(19) United States
(12) Patent Application Publication
(10) Pub. No.: US 2014/0222783 A1
(43) Pub. Date: Aug. 7, 2014

(54) SYSTEMS AND METHODS FOR AUTOMATICALLY DETERMINING AN IMPROVED VIEW FOR A VISUAL QUERY IN A MOBILE SEARCH

(71) Applicants: Shih-Fu Chang, New York, NY (US); Xinnan Yu, Beijing (CN); Rong-Rong Ji, Xiamen (CN); Tongtao Zhang, Shanghai (CN)

(72) Inventors: Shih-Fu Chang, New York, NY (US); Xinnan Yu, Beijing (CN); Rong-Rong Ji, Xiamen (CN); Tongtao Zhang, Shanghai (CN)

(73) Assignee: THE TRUSTEES OF COLUMBIA UNIVERSITY IN THE CITY OF NEW YORK, New York, NY (US)

(21) Appl. No.: 13/983,265

(22) PCT Filed: Apr. 16, 2012
(86) PCT No.: PCT/US2012/033833

§ 371 Date: Apr. 16, 2014

Related U.S. Application Data
(60) Provisional application No. 61/477,844, filed on Apr. 21, 2011.

(51) Int. Cl. G06F 17/30

(52) U.S. Cl. CPC G06F 17/30277
USPC 707/722

(57) ABSTRACT

Systems and methods for automatically determining an improved view for a visual query in a mobile location or object search are provided. In some embodiments, methods for automatically determining an improved view for a visual query in a mobile location or object search system include obtaining at least one data set based on a prior visual query, wherein the at least one data set includes at least a top location or object and one or more other locations or objects; retrieving at least one distinctiveness measurement for one or more locations or objects in the at least one data set; and determining the improved view based on the retrieved at least one distinctiveness measurement.

### CROSS REFERENCE TO RELATED APPLICATIONS

This application claims priority to U.S. Provisional Patent Application Ser. No. 61/477,844, filed on Apr. 21, 2011 the entirety of the disclosure of which is explicitly incorporated by reference herein.

### TECHNICAL FIELD

The disclosed subject matter relates to mobile visual search technology, and more particularly to an automated Active Query Sensing system for sensing surrounding scenes or different views of objects while forming a subsequent search query.

### BACKGROUND ART

As mobile handheld devices have become pervasive, new technologies such as mobile media search have emerged. One such example includes systems for searching information about products, locations, or landmarks, by taking a photograph of the target of interest near the mobile user. The captured image can be used as a query, sent via the mobile network to the server in which reference images of the candidate objects or locations are matched in order to recognize the true target. Such mobile visual search functionalities have been used in commercial systems, such as “snaptel” (http://www.snaptell.com), Nokia “point and find” (http://www.pointandfind.nokia.com), “kooaba” (http://www.kooaba.com), as well as others. Taking mobile location search for example, certain mobile location search systems can offer features and services complementary to GPS or network-based localization, in part because the recognized location in mobile location search systems can be more precise, and no satellite or cellular network infrastructures are needed. Similar cases also exist in other related scenarios such as mobile product search and mobile poster search.

Certain mobile visual search systems are built based on image matching, the success of which can depend on several factors, including the separability of image content associated with different targets (inter-class distance), divergence of content among reference images of the same target (within-class variation), and distortion added to the query image during the mobile imaging process. Every reference image of a target can potentially be used as a query to successfully recognize the true target and properly reject other targets. However, such systems can suffer from unreliability and failed queries, and can therefore result in user frustration.

### SUMMARY

Systems and methods for automatically determining an improved view for a visual query in a mobile search are disclosed herein.

In some embodiments, methods for automatically determining an improved view for a visual query in a mobile search system include obtaining at least one result data set based on a prior visual query, wherein the at least one result data set includes at least a top result and one or more other results; retrieving at least one distinctiveness measurement for one or more views of one or more objects in the at least one result data set; and determining the improved view based on the retrieved at least one distinctiveness measurement.

In certain embodiments, determining the improved view utilizes an information gain maximization process and/or a majority voting process. In further optional embodiments, the method can include estimating a viewing angle of the prior query and determining outlier results, if any, from the at least one result data set based on the estimated viewing angle of the prior query, and removing from the at least one result data set the determined outlier results using machine learning classification (e.g., Support Vector Machine) and/or local feature matching based image alignment. In certain embodiments, the estimate is refined based on machine learning classification using image matching results from comparing the prior query and one or more results in the at least one result data set.

In other embodiments, the method can include providing a suggested view change for the current visual query to a mobile search system user based on the difference between the viewing angle of the prior query and the determined improved view. The method can also include providing images of one or more views of one or more results from the at least one result data set, and/or prompting the user to indicate whether the improved view is to be determined. In some embodiments, the retrieving and determining can be initiated after the user has indicated that the improved view is to be determined. In other embodiments, the retrieving and determining can be initiated independent of whether the user has indicated that the improved view is to be determined, and the suggested view change can be provided after the user has indicated that the improved view is to be determined.

In some embodiments, the distinctiveness measurements of at least one view for the one or more results in the at least one result data set are pre-computed using one or both of content based view distinctiveness prediction and training performance based view distinctiveness prediction.

Some embodiments involve visual location queries. In such embodiment, the method can further include removing from the at least one result data set the top result and all other results geographically close to the top result, wherein the top result of the at least one result data set is deemed incorrect.

In other embodiments, non-transitory computer-readable media have a set of instructions programmed to perform the methods for automatically determining an improved view for a visual query in a mobile search system described above.

Another embodiment provides an active query sensing system for automatically determining an improved current view for a visual query in a mobile search. The system can include a mobile visual search device configured to obtain at least one result data set based on a prior visual query, where the data set includes at least a top result and one or more other results. The system can also include a determination module, configured to retrieve at least one distinctiveness measurement for each of the results in the data set, and determine the improved view based on the retrieved distinctiveness measurement. The system can also include a user interface module coupled to the determination module, configured to provide images of one or more views of results from the data set. The system can also include a distinctive view learning module, coupled to the determining module, and configured to pre-compute the distinctiveness measurements using one or both of content based view distinctiveness prediction and training performance based view distinctiveness prediction.

### BRIEF DESCRIPTION OF DRAWINGS

FIG. 1 illustrates multiple views of a 3D object.

FIG. 2 illustrates an active query sensing system for automatically determining an improved current view for a visual query in a mobile location search according to some embodiments of the disclosed subject matter.

FIG. 3 illustrates an active query sensing system for automatically determining an improved current view for a visual query in a mobile location search according to some embodiments of the disclosed subject matter.

FIG. 4A is a bar graph illustrating image matching performance of small codebook configurations.

FIG. 4B is a bar graph illustrating image matching performance of million sized codebook configurations.

FIG. 5A illustrates queries taken from various views according to some embodiments of the disclosed subject matter.

FIG. 5B illustrates the top four returned images corresponding to each query shown in FIG. 5A, according to some embodiments of the disclosed subject matter.

FIG. 5C illustrates the geographical distribution of returned location of different views according to some embodiments of the disclosed subject matter.

FIGS. 6A-6D are charts illustrating score distributions of various views.

FIG. 7 illustrates the geographical distribution of the five routes in the NAVTEQ New York City data set.

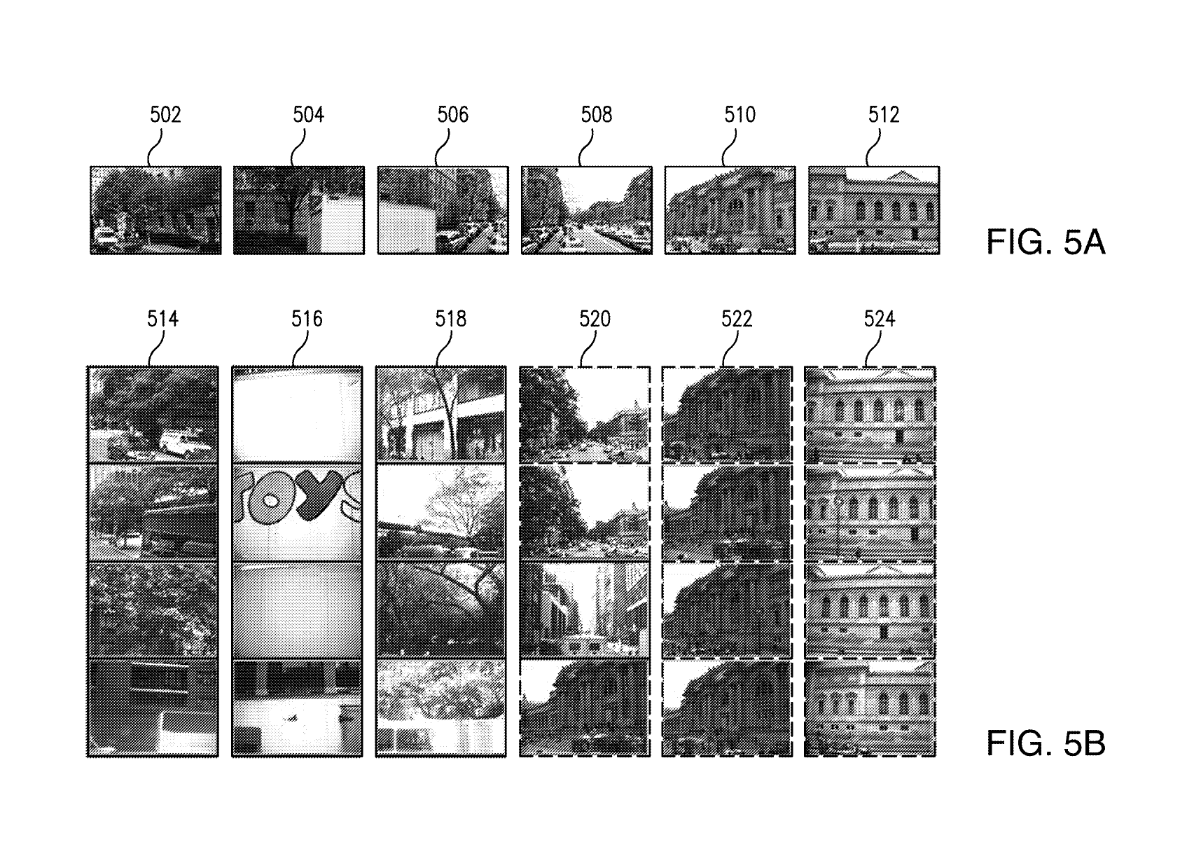

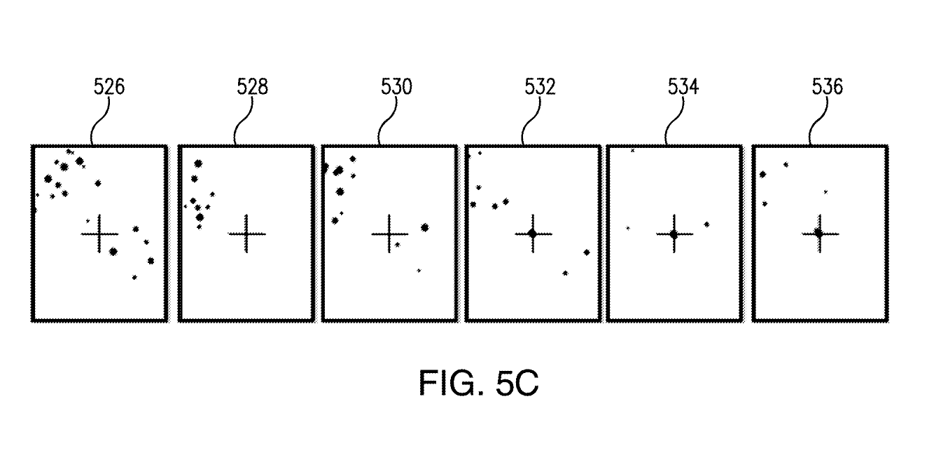

FIG. 5A illustrates the visual coverage of six cameras in the NAVTEQ NYC data set.

FIG. 8B illustrates an example of six views of one location of the NYC street view data set.

FIG. 8C illustrates an example panorama view in the NAVTEQ NYC data set.

FIG. 9 illustrates the cropping of the Google Street View interface to simulate online mobile queries.

FIG. 10A is a bar graph illustrating the percentage of locations in a test query set with different numbers of searchable views.

FIG. 10B illustrates the distribution of test query locations with different degrees of searchability over a geographical area.

FIG. 11 is a line graph illustrating the failure rates over successive query iterations based on different active query sensing strategies according to some embodiments of the disclosed subject matter.

FIG. 12 illustrates the geographical location confidence distribution in New York City with respect to different views, according to some embodiments of the disclosed subject matter.

FIG. 13 is a confusion matrix for location search difficulty prediction according to some embodiments of the disclosed subject matter.

FIG. 14 illustrates a user interface according to some embodiments of the disclosed subject matter.

FIG. 15 illustrates a user interface according to some embodiments of the disclosed subject matter.

FIG. 16 is an illustration of a computer system suitable for implementing an exemplary embodiment of the disclosed subject matter.

FIG. 17 is a block diagram illustrating the components of an Active Query Sensing system according to some embodiments of the disclosed subject matter.

### DETAILED DESCRIPTION

Embodiments of the disclosed subject matter can automatically determine a suggested improved view angle for a visual query in a mobile search system after a user has indicated that the top returned result of an initial search list of candidate locations is incorrect. The view angle of the initial query can be estimated based on information in the query image. An offline distinctive-view (i.e., the view from a given location most likely to return a correct search result) learning system analyzes images of known locations to determine a most recognizable viewing angle for such locations. The most distinctive view for each remaining candidate location can be retrieved from the offline distinctive-view learning system and majority voting can be performed to determine the likely most distinctive view for the search location. This can then be compared with the estimated actual view to provide the user with suggested instructions (e.g., turn right 90 degrees) for improving the chances of subsequent query success over random view selection.

Although the descriptions herein are focused on using mobile visual search to determine locations, the disclosed subject matter can be applied more generally to search various objects and scenes in the physical world, including but not limited to products and 3D objects, in addition to geographical locations.

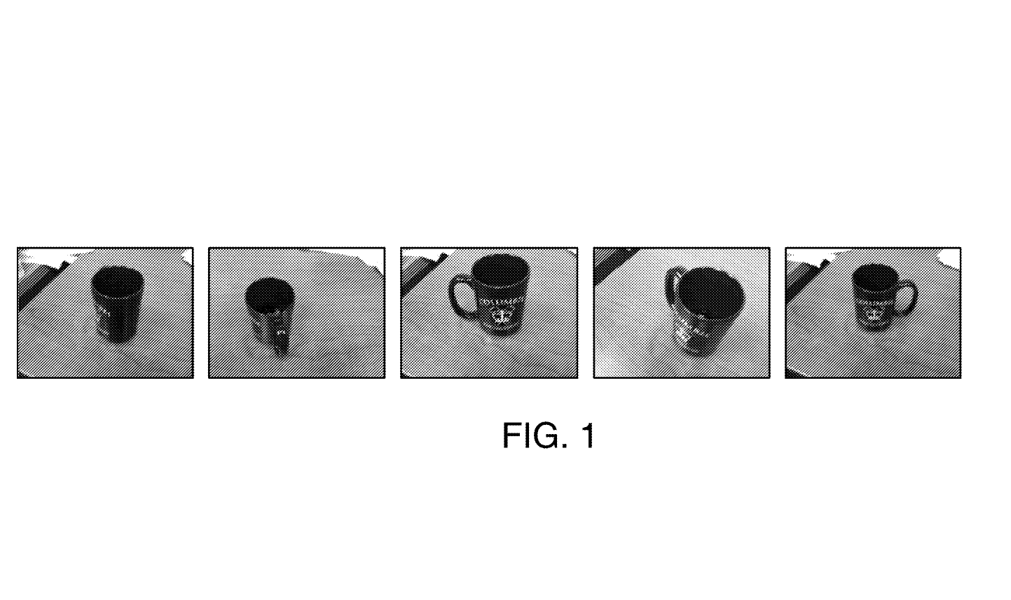

Different views of 3D objects, locations, etc. produce images with varying degrees of distinctiveness, i.e., the degree to which a particular object or location can be identified based on the information contained in the image. As used herein, the term “view” refers to the orientation, scale, and location for taking a picture as a visual query input. FIG. 1, for example, shows various views of the same object, each having varying degrees of distinctiveness. As a result of this variation, some views are more distinctive than others, and are therefore more likely to return correct search results when used as image queries.

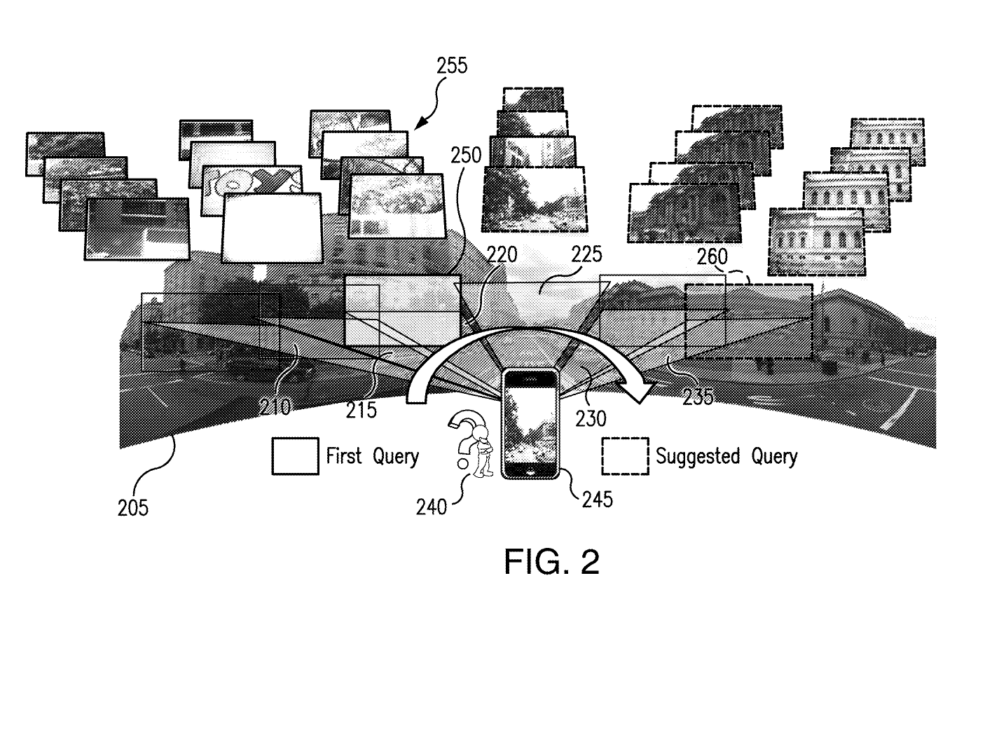

FIG. 2 shows an example use of an embodiment of the disclosed subject matter. The panoramic background 205 of the location shown in FIG. 2 includes six candidate views: back left 210, left 215, front left 220, front 225, front right 230, and right 235. A user 240 operates a mobile location search device 245 to make a first query 250 with a view angle corresponding to the front left view 240. In this example, the mobile location search device is an Apple iPhone, but other devices with mobile location search capabilities can be used. A set of candidate locations 255 is returned by the mobile search device 245 in response to the first query 250. Four candidate locations are shown, but any number of results can be returned. Example results for the remaining views are also shown. Not every view of a location is distinctive enough to be used as a successful query, as illustrated in FIG. 2. In the initial query, the back left view 210, left view 215, and front left view 220 return all incorrect results; the front view 225 returns one correct result out of four candidate locations; and the front right view 230 and right view 235 return all correct locations.

When these types of searches fail, incorrect locations with visually similar appearances typically are returned as the top match. This performance appears to be generally consistent with the modest accuracy (0.4-0.7 average precision) reported in some of the prior art systems for mobile location search. In the example shown in FIG. 2, when the user 240 indicates that the top returned candidate location is incorrect, the mobile location search device 245, using the subject matter disclosed in more detail below, suggests an improved view for the next query 260.

The disclosed subject matter focuses on a novel aspect of improving the mobile visual search experience based on the existence of unique preferred views for successful recognition of each target location. For example, some views of a location consist of unique “signature” attributes that are distinctively different from others. Other views can contain common objects (trees, walls, etc.) that are much less distinctive. When searching for specific targets, queries using such unique preferred views will typically lead to much more robust recognition results. To this end, the disclosed subject matter includes an automated Active Query Sensing (“AQS”) system to automatically determine an improved view for visual sensing to formulate a visual query.

Fully automatic AQS can be difficult to achieve for the initial query when the user location is initially unknown to the system. In such cases, location-specific information helpful for determining an improved view for a visual query can initially be unavailable. Although some prior information (e.g., GPS data, base station tags, previously identified locations, and trajectories) can be available for predicting the likely current locations, that information is not always reliable. The disclosed subject matter can improving the success rate of subsequent queries when prior queries have failed. Specifically, the disclosed AQS system can include two components: offline distinctive view learning and online active query sensing.

First, the disclosed systems provide automatic methods for assessing the “distinctiveness” of views associated with a location. Such distinctiveness measures are determined using an offline analysis of the matching scores between a given view and other images (including those of the same location and different locations), unique image features contained in the view, or combinations thereof. The proposed distinctiveness measure can provide much more reliable predictions about improved query views for mobile location recognition, compared with alternatives using random selection or the dominant view.

Second, the disclosed systems can use the prior query as a “probe” to narrow down the search space and form a small set of candidate locations, from which the prior query is aligned. The optimal view change (e.g., turn to the right of the prior query view) is then estimated in order to predict an improved or best view for the next query.

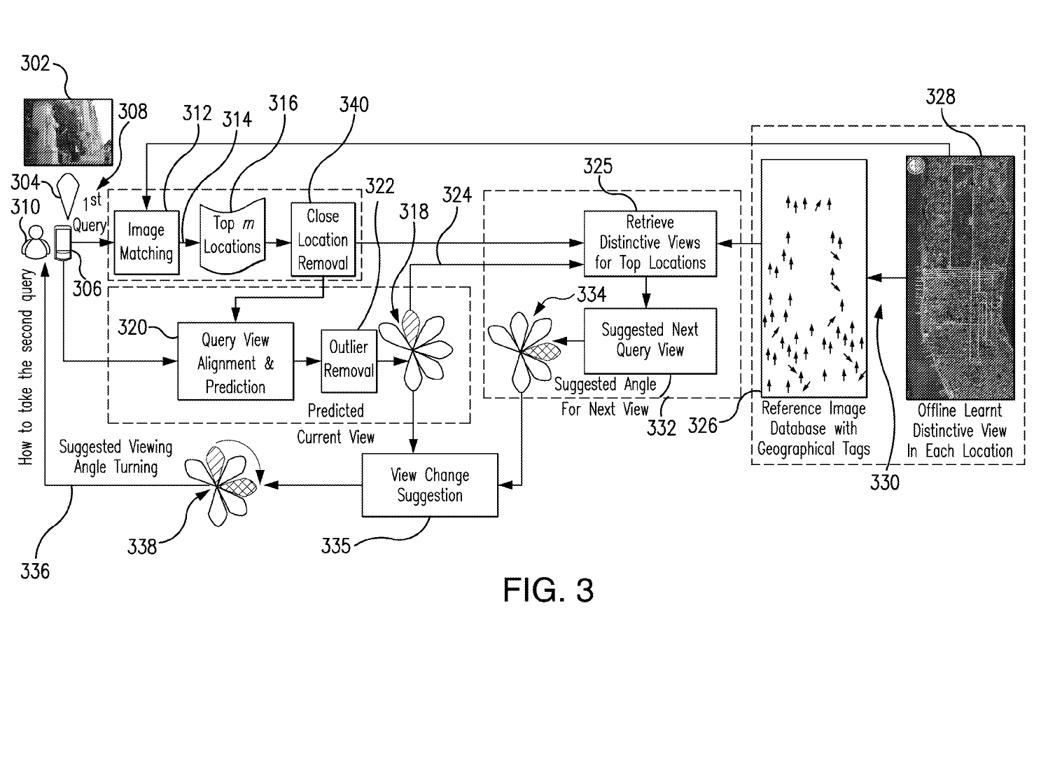

FIG. 3 shows an overall architecture and process flow of an embodiment of the disclosed subject matter. Given a prior query 302 taken at a prior view 304 using a mobile location search device 306 and submitted 308 by the user 310, the image matching component 312 computes the scores for the reference images and returns 314 the candidate locations 316. If the user initiates a subsequent search at the same location, or otherwise initiates the AQS system, the active view suggestion process begins. In this example, the user initiates a subsequent search by indicating that the first returned candidate location is incorrect. However the reasons for repeating a search are not limited to incorrect results; other reasons, such as a desire to confirm the initial results using a different query view, or other reasons for subsequent searching, will be apparent to a person of ordinary skill in the art. In other embodiments, the system can pre-process the AQS search automatically without waiting for or requiring user initiation, which can result in a faster and more user-friendly experience. Such a feature can be an option capable of being turned on and off in system settings depending on the user's preference.

The most likely view of the current query image 318 can be estimated 320 through coarse classification of the query image to some of the predefined views (e.g., side, front-back) and then refined by aligning the query image to the panorama or the multi-view image set associated with each of the top candidate locations. Such alignment process can also be used to filter out outlier locations 322 that are inconsistent with the majority of the candidate locations in terms of prediction of the current query view.

The filtered candidate location set can then be used 324 to retrieve 325 the distinctive views 326 associated with each possible location 328, which have been pre-computed offline 330. A majority voting process 332 can be used to determine the suggested view 334 for the next query. The difference between the suggested query view and the predicted current view can be used 335 to suggest 336 a view change 338 to the user 310, who can then turn the mobile location search device 306 according to the suggested change 338, and submit the next query.

Optionally, the initial set of candidate locations 316 can be reduced by removing the top returned location deemed incorrect by the user and/or locations nearby 340. Such locations can be the duplicates of or closely related to the incorrect location, and therefore unlikely to be correct locations.

In an example embodiment, approximate image matching is achieved in a million-scale image database using bag of visual words (“BoW”) with inverted indexing technique. The embodiment uses a hierarchical tree based structure for efficient codebook construction and visual local feature quantization. In addition, multi-path search and spatial verification can also be incorporated to improve accuracy.

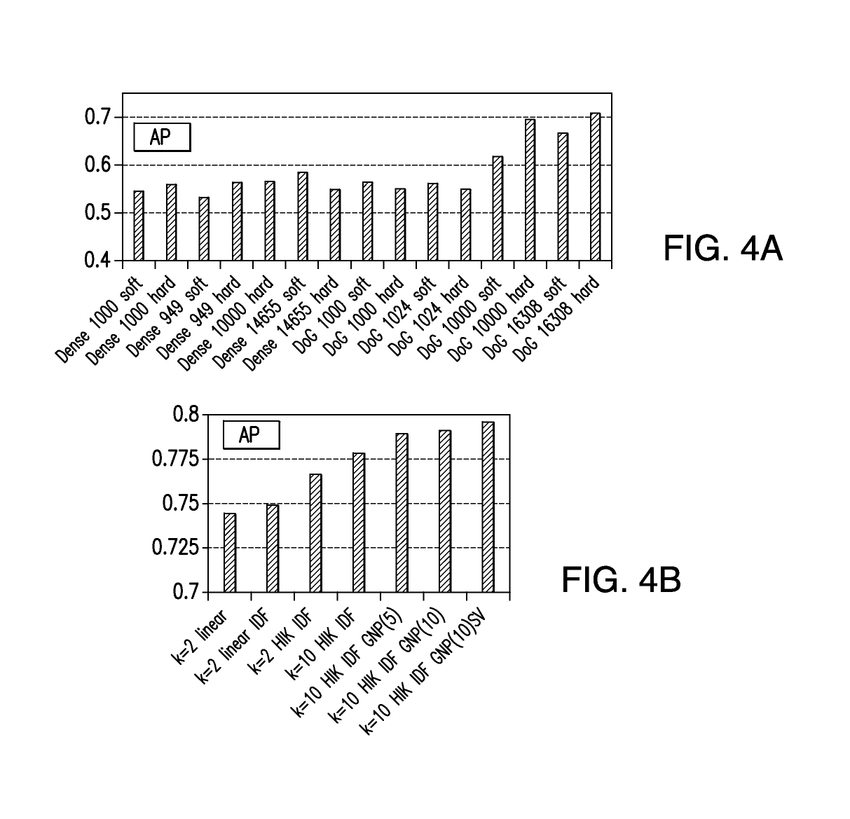

FIG. 4 shows a comparison of image matching performance among varying configurations of an embodiment of the disclosed subject matter using a validation set based on the NAVTEQ NYC data set. FIG. 4A shows the performance of small codebook configurations with varying local detector, codebook size, hierarchical clustering, and quantization. FIG. 4B shows the performance of million-sized codebook configurations with varying branching factors, histogram intersection kernel, GNP search, IDF, and spatial verification.

Local Feature Extraction:

Both interest point detection and dense sampling can be used in building the search system. The former can be based on Difference of Gaussian (“DoG”), while the latter can be based on multi-scale sliding window with three scales and fixed steps, producing approximately equal numbers of local features. As shown in FIG. 4A, DoG typically outperforms dense sampling under different configurations of codebook size and quantization methods.

Local Feature Clustering:

Hierarchical K Means Clustering can be used to build the million-scale visual vocabulary. There are two basic settings in building the Vocabulary Tree: (1) Branching Factor B controls how many clusters are built to partition a given set of local features into its lower hierarchy, and (2) Hierarchical Layer H controls the number of hierarchical layers in the tree. There is a tradeoff between speed and quantization accuracy in choosing different B and H values. In an example configuration, with empirical validation, B=10 and H 6 can be set to construct a final codebook of approximately 1 million codewords.

Quantization:

Soft quantization can improve the retrieval precision.

In an example configuration, soft quantization performs better when the codebook size is small. But as the codebook size increases, the performance of soft quantization degrades, and is outperformed by hard quantization. Greedy N-Best Path (“GNP”) can be used to rectify the quantization errors by searching multiple paths over the quantization tree. By using GNP of 10 paths, a further gain in average precision (2%) can be achieved.

Spatial Verification:

Spatial matching can also be incorporated into the image matching. Using spatial matching, a point in one image is considered to match a point in another image if a sufficient number of nearby local features are also matched.

Inverted Indexing:

Finally, Histogram Intersection Kernel (“HIK”) can be implemented in the image matching system together with inverted indexing to ensure scalability to the million-scale database. Once a certain amount of local descriptors from one query are assigned into a given visual word, all images indexed by this visual word can be assigned a certain score.

The final one million codebook configuration in an example embodiment of the disclosed subject matter is shown in Table 1. The performance of the final system has an average precision at 0.7961 over some validation set using the reference images as queries.

The disclosed AQS system can be used independent of the image matching subsystem if the query view is location dependent.

TABLE 1
Final One Million Codebook Configuration

| Component | Choice |
|---|---|
| Local Feature | DoG + SIFT |
| Clustering | Hierarchical K Means (B = 10; H = 6) |
| Quantization | Hard Quantization with GNP N = 10 |
| Inverted Indexing | HIK kernel based |
| Spatial Verification | Neighborhood Voting |
| Word Frequency | TF-IDF |

Offline Distinctive View Learning

As discussed above, each location has certain views that are more distinctive and can be used for successful retrieval. Referring now to FIG. 5, six queries are made at a location using six different views: back left 502, left 504, front left 506, front 508, front right 510, and right 512, as shown in FIG. 5A. FIG. 5B shows the top four returned results for each query view. In this example, the back left view 502, left view 504, and front left view 506 return all incorrect results (514, 516, and 518). The front view 508 returns one correct result out of four candidate locations (520). The front right view 510 and right view 512 return all correct views (522 and 524). FIG. 5C shows the geographical distribution of returned locations of different views. A cross represents the actual query location and locations of the matched images are shown in different sizes according to the rank orders.

Two approaches can be used to pre-compute distinctive views of a given set of locations: content-based view distinctiveness prediction and training performance based view distinctiveness prediction. The former explores the unique attributes contained in each view such as distinct objects, local features, etc., while the latter predicts the test performance by assessing the query effectiveness over a training data set. Embodiments of the disclosed subject matter can incorporate either or both. Note in the discussion below, it is assumed that the continuous space of view can be appropriately discretized, for example, to a finite set of choices (e.g., six angles used in the NAVTEQ data set). Other discretizations can be used and will be apparent to a person of ordinary skill in the art.

Content Based View Distinctiveness Prediction:

With the BoW representation, distinctive visual words typically have a better discriminating power than words that appear frequently in the databases. A word can be considered more distinctive if its frequency of occurrence in the database images (documents) is low. Extending this concept, a TF-IDF related content-based feature can be defined as follows:

F(k)=count(wordᵢ|IDF(wordᵢ)>k/K×IDFₘₐₓ), (1)

where k=1, 2, . . . , K−1. If K is set to be 10, then the above feature accounts for the number of visual words whose IDF exceed certain thresholds (up to 90% with 10% increment). As a result, images of distinctive views will have more words at high IDF than others.

A Support Vector Machine (“SVM”) based classifier can be trained and its classification score used to predict the distinctiveness of an image. For example, a subset of geo-tagged locations sampled from Google Street View can be used as a labeled training set to train the SVM classifier. Since the feature dimension is kept low (10 if K=10), a training set of such a size is adequate.

Training Performance Based View Distinctiveness Prediction:

Each location is associated with a finite set of reference images captured in different views. Each of the reference images can be used to query the database and evaluate its capability in retrieving related images of the same location, or other locations sharing overlapped scenes. Although there can be a gap between such training performance and the real test performance when querying by new images that have not been seen before, the score distributions of relevant (positive) images and irrelevant (negative) images can serve as an approximate measure.

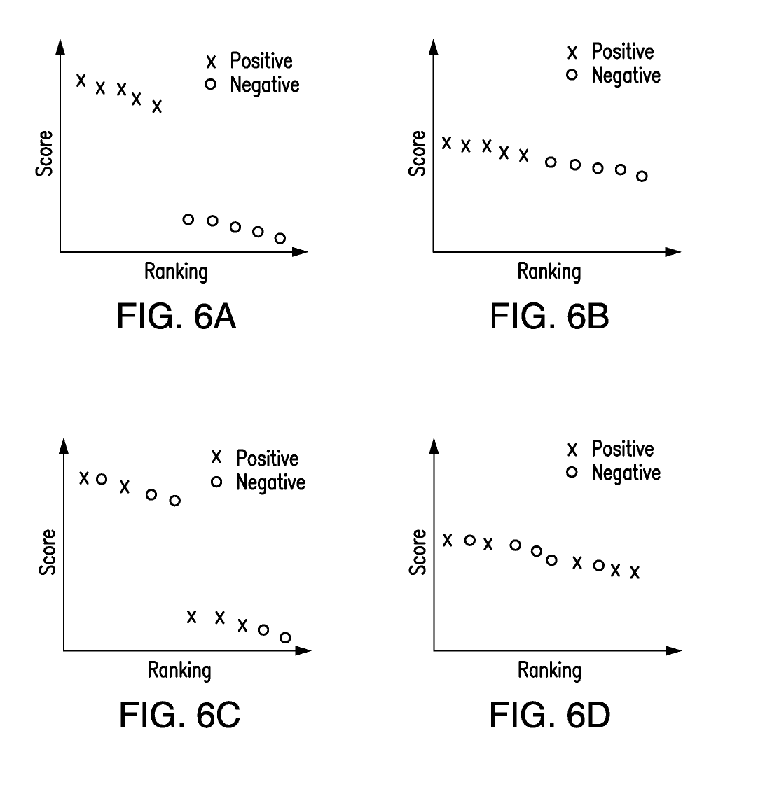

An ideal score distribution is the one that has maximal separation between the scores of the positive results and those of the negative ones, e.g., the score distribution shown in FIG. 6A. Scores that have very small separation (e.g., FIG. 6B) or mixed results (e.g., FIGS. 6C and 6D) do not generalize well. To approximate the robustness of such query results, two methods can be implemented. The first one is based on a commonly used metric, average precision (“AP”), as defined below:

$$AP = \frac{{\sum }_{r = 1}^{{N}_{relevant}} P ( r )}{{N}_{relevant}} . \qquad ( 2 )$$

Nᵣₑₗₑᵥₐₙₜ is the number of relevant documents to the current query; r is the rth relevant document; P(r) is the precision at the cut-off rank of document r. In the literature, there are some subtle variations in definition of AP. The one used above is also called full-length AP.

The other method, called Saliency as defined below, is similar to AP with several modifications. First, the ratio of the positive score statistics to that of the negative scores are computed. Second, the actual score values are incorporated in the measure. These modifications incorporate the score separation between the positive and negative classes:

$$Saliency = \frac{{\sum }_{i = 1}^{N} {\sum }_{j = 1}^{i} score ( j ) rel ( j ) / i}{{\sum }_{i = 1}^{N} {\sum }_{j = 1}^{i} score ( j ) \overline{rel} ( j ) / i} , \qquad ( 3 )$$

where N is the number of returned locations, which can be a fixed size or adjusted based on the number of positive samples. score(j) is the location matching score, which is the maximal score of its six views. rel(j) is the relevance judgment of the jth returned location, which gives 1 for correct locations and 0 for incorrect. Other statistical measures, such as KL Divergence, can also be used.

Note the numerator in Equation 3 above is very similar to that of AP (described in Equation 2), except the score values are used instead of binary values (1 for positive and 0 for negative) and the inner average is repeated for every sample, not just the positive points. Despite the simplicity of the above Saliency measure, it can yield high prediction accuracy.

The offline measures of distinctiveness for each view can also be used to “grade” the searchability of a location. Based on the search results of the associated views, a location can be categorized into one of the following groups:
View-Independent Confident Location: Users can take photos in any arbitrary view to find this location.
View-Dependent Searchable Location: Users can take photos in certain views to find this location.
Difficult Location: Users cannot find this location no matter which view he/she uses to form the visual query.

The above analysis can also be used with certain modifications. First, the offline analysis is not limited to the discrete views that have been indexed in the database. In practice, users can sample the view space in a more flexible manner. Second, there can be a generalization gap between offline analysis based on training performance and the real-world online testing. Nonetheless, the offline analysis offers an approximate yet systematic process of discovering the preferred query views for searchable locations.

Online View Estimation and Active Query Sensing

Modules for online view estimation and active query view suggestion are described in this section. An example process is summarized in Algorithm 1. Given a prior query that fails to recognize the correct location, the objective is to develop automatic methods that can estimate the likely view captured by the prior query, and from the candidate location set, discover an improved or the best view for the next query.

Algorithm 1: Online view estimation and Active Query
Sensing procedure

| | |
|---|---|
| 1 | Given query q, get the top N most likely locations |
| 2 | if the first location is incorrect then |
| 3 | \| Obtaining candidate location set \hat{L} { |
| 4 | \| Remove locations in the top-N set that are |
| | \| geographically close to the first location; |
| 5 | \| Predict the viewing angle of the first query based on |
| | \| the GIST feature together with the voting refinement |
| | \| (Equation 4); |
| 6 | \| Discard the outlier locations with predicted viewing |
| | \| angles inconsistent with that obtained in the former |
| | \| process; |
| 7 | \| } |
| 8 | \| Majority voting within \hat{L} { |
| 9 | \| for l ε \hat{L} do |
| 10 | \| \| Retrieve the distinctiveness measurements of the remaining |
| | \| \| view set Θ; |
| 11 | \| \| Estimate the camera movement to the most distinctive |
| | \| \| view in l; |
| 12 | \| end |
| 13 | \| Majority voting to determine improved/best view for the |
| | \| second query. |
| 14 | \| } |
| 15 | end |

Using the image matching subsystem, first a small set of top-N most likely locations can be identified. In the case in which the user has indicated that the top matched location is incorrect, the first location and locations geographically close to the first location can be removed as the first location has been deemed incorrect by the user. The definition of “geographically close” can vary depending on the circumstances. The system can either have a default definition, e.g., 50 meters, or prompt or allow the user to set a value, or both. Next, an SVM classifier can be employed to assign the prior query image to one of a few rough orientations, followed by refinement based on image matching. Algorithm 1 shows the working pipeline of an embodiment of the active query sensing system of the disclosed subject matter. Some key components of Algorithm 1 are explained in detail below.

Viewing Angle Prediction:

Although the visual content in different views of the location database can be very diverse, there exist general patterns differentiating each other. For example, the side views tend to contain more features related to buildings, trees, and sides of parked vehicles, while other views (e.g., front) have more attributes like skylines, streets, and front/back views of vehicles. Such differences tend to be holistic, reflecting the overall characteristics of the scenes, thus motivating the choice of GIST descriptor for view classification.

The SVM classifiers can be trained offline based on GIST features extracted from 3000 images (500 for each view) randomly chosen from a database. Given an online query, the classifier is used to predict the current viewing angle in a one-versus-all manner. GIST features are efficient in describing the global configuration of images. However, as shown in FIG. 8, discussed below, certain views can have very similar visual appearances. To address this problem, a further refinement based on the image matching results can be used:

$${argmax}_{{θ}_{i }} {\sum }_{l} P ( {θ}_{i} \vert l , q ) P ( l \vert q ) , \qquad ( 4 )$$

where O is a candidate view under consideration, P(θᵢ|l, q) is the matching score between query q and view i of location l, and P(l|q) is the prior of location l. The prior can be obtained by additional metadata about locations such as GPS or the history data about the user locations. The default is a constant for all locations.

This refinement is based on the principle that similar views, even from different locations, typically have similar visual contents (e.g., skylines, side of a truck etc.), which are more likely to be included in the top image match results. Therefore, the final angle prediction method can be based on both the combination of both local feature (scale-invariant feature transform (SIFT) for image matching) and global feature (GIST for SVM classification). This approach is robust in application scenarios. It should be noted that when the solution space for view prediction (and alignment) is large, a more sophisticated correspondence matching method, such as RANSAC, can be useful to reliably align the query image to the panorama associated with each location.

Once the current query view is estimated, it can be used it to filter out the outlier locations that do not share consistent view estimation.

Majority Voting for View Suggestion:

Given the filtered candidate set of the locations, a majority voting scheme can be used to estimate the most beneficial view to be used as the next query. It can be expressed as:

$${argmax}_{θ ∈ Θ} {\sum }_{l ∈ \hat{L}} {H}_{distinctiveness} ( {θ}_{i} \vert l , q ) P ( l \vert q ) , \qquad ( 5 )$$

where H_{distinctiveness} (θᵢ|l, q) outputs 1 if the distinctiveness of view θᵢ and location l is greater than a threshold. P(l|q) can be used to model the prior of location l given query q. Such prior can be obtained from rough. GPS information, history of the mobile user location, etc. The default of P(l|q) is a constant for all locations leading the equation to a majority voting.

The scheme takes into account the distinctiveness of each view with respect to each remaining candidate location, as well as the location priors. With the estimated improved query view and the view angle of the current query, suggestions can be made to inform the user of an improved way of turning or moving the camera phone for the subsequent visual search.

AQS can also be used to maximize information gain about the target location while selecting additional query views. In an example embodiment, where [symbol] is the set of database locations, [symbol] is the set of possible views, and [symbol] is the set of possible query images, the location lε [symbol] can be found using given user queries.

The user can take a query image from a certain viewing angle at time t=1. Then for each iteration t, if the correct location is not ranked first among the result, an additional query view is suggested.

Defining q, as the query taken at iteration t, there are two parts in qₜ=(mₜ, vₜ): mₜ, the actual image used for the query, and vₜ, the viewing angle used in capturing the image. Both components are included because actual captured images in a certain view direction at a location can still vary due to the changes of time, lighting, traffic, or even the devices used. If V^{t-1} is defined as the views already tried, then the remaining candidate view Vₜε [symbol] −V^{t-1}. For simplicity, an embodiment will be described in which the view of the query image is known, followed by an embodiment in which the viewing angle of the query is unknown.

Supposing queries have failed for iterations 1 . . . t−1, with query set Q^{t-1}, the expected information gain (“IG”) can be used as a criterion to select the query viewing angle vₜ.

$${v}_{t} = {max}_{{v}_{t} ∈ V - {V}^{t - 1}} {𝔼}_{{m}_{t}} ( IG ( 𝓁 ; {v}_{t} \vert {Q}^{t - 1} ) ) . \qquad ( 6 )$$

The term for maximization represents the expected information gain after a specific view angle vₜ is chosen in iteration t by choosing an angle that maximizes the information gain. The expectation can be computed over possible images under different imaging conditions as discussed above. From the definition of information gain:

$$\begin{matrix}{𝔼}_{{m}_{t}} ( IG ( 𝓁 ; {v}_{t} \vert {Q}^{t - 1} ) ) & ( 7 ) \\ = {\sum }_{{m}_{t} ∈ M} p ( {m}_{t} \vert {Q}^{t - 1} , {v}_{t} ) ( H ( 𝓁 \vert {Q}^{t - 1} ) - H ( 𝓁 \vert {Q}^{t - 1} , {q}_{t} ) ) , & ( 8 )\end{matrix}$$

where,

$$H ( 𝓁 \vert {Q}^{t - 1} ) = - {\sum }_{𝓁 ∈ ℒ} p ( 𝓁 \vert {Q}^{t - 1} ) log p ( 𝓁 \vert {Q}^{t - 1} ) ,$$

is the entropy of p(l|Q^{t-1}) H (l|Q^{t-1}) is a constant given Q^{t-1}. p(Q^{t-1}) can be modeled as

$$p ( 𝓁 \vert {Q}^{t - 1} ) {=}^{Δ} \frac{{\sum }_{i = 1}^{t - 1} p ( 𝓁 \vert {q}_{i} ) w ( {q}_{i} )}{{\sum }_{i = 1}^{t - 1} w ( {q}_{i} )} . \qquad ( 9 )$$

in which p(l|qᵢ) can be directly approximated by using the score distribution of locations, given query qᵢ. In some embodiments, in each iteration, p(l|qᵢ) is set to 0 for all the locations that have been determined incorrect by the user. w(qᵢ) indicates the “weight” or “quality” of query qᵢ, which can be estimated by analyzing the content or quality of query qᵢ. Less informative images, e.g., images with mostly trees, cars, etc. and images with low quality, typically have lower influence on location prediction.

Without actually getting the query image, mₜ, and even if angle vₜ is fixed, Equation 9 cannot be directly applied to determine p(l|Q^{t-1},qₜ). However, mₜ can be approximated using the references images stored in the database, query images submitted earlier by users from the same angle vₜ of similar time, etc. Thus, p(l|Q^{t-1},qₜ) can be approximated as

$$p ( 𝓁 \vert {Q}^{t - 1} , {\tilde{q}}_{t} ) = \frac{{\sum }_{i = 1}^{t - 1} p ( 𝓁 \vert {q}_{i} ) w ( {q}_{i} ) + p ( 𝓁 \vert {\tilde{q}}_{i} ) w ( {\tilde{q}}_{t} )}{{\sum }_{i = 1}^{t - 1} w ( {q}_{i} ) + w ( {\tilde{q}}_{t} )} , \qquad ( 10 )$$

where w(qᵢ) can be modeled using various well-known methods, such as Saliency. For the first term of Equation 8, p(mₜ|Q^{t-1}), by using the approximation mentioned above,

$$\begin{matrix}p ( {m}_{t} \vert {Q}^{t - 1} , {v}_{t} ) = {\sum }_{l} p ( {\tilde{m}}_{t} , l \vert {Q}^{t - 1} , {v}_{t} ) & ( 11 ) \\ = {\sum }_{l} p ( {\tilde{m}}_{t} \vert l , {v}_{t} ) p ( l \vert {Q}^{t - 1} , {v}_{t} ) . & ( 12 )\end{matrix}$$

Assuming the new captured image in angle vₜ at location l can be approximated by the existing reference image corresponding to the same location and view angle in the database, then the first term in Equation 12 becomes deterministic and Equation 9 becomes:

$${\sum }_{l} p ( l \vert {Q}^{t - 1} ) ( H ) ( l \vert {Q}^{t - 1} ) - H ( l \vert {Q}^{t - 1} , {q}_{t} ) . \qquad ( 13 )$$

If the entropy reduction term in the above equation is further approximated with the Saliency measure previously introduced, then the same method based on majority voting described in Equation 5 is obtained. This can be beneficial because the majority voting method is straightforward and simple to compute.

When the query viewing angle is unknown, the estimation method described above, (“Online View Estimation and Active Query Sensing”) can be applied to predict the most likely view angle of the initial submitted query. Alternatively, the query image can be aligned to the associated reference images of each location. This can result in different aligned angles with respect to different candidate locations because the query image can look very similar to one view for a specific candidate location, but look less similar to a different view for the other candidate location. In such a case, instead of maximizing the expected information gain by choosing a single best angle vₜ, the optimal relative change of the view angle can be found to maximize the information gain. If the majority of the candidate locations agree on the optimal angle change, a consistent turning action can be recommended.

### Example 1

### Analysis of a Prior Art System

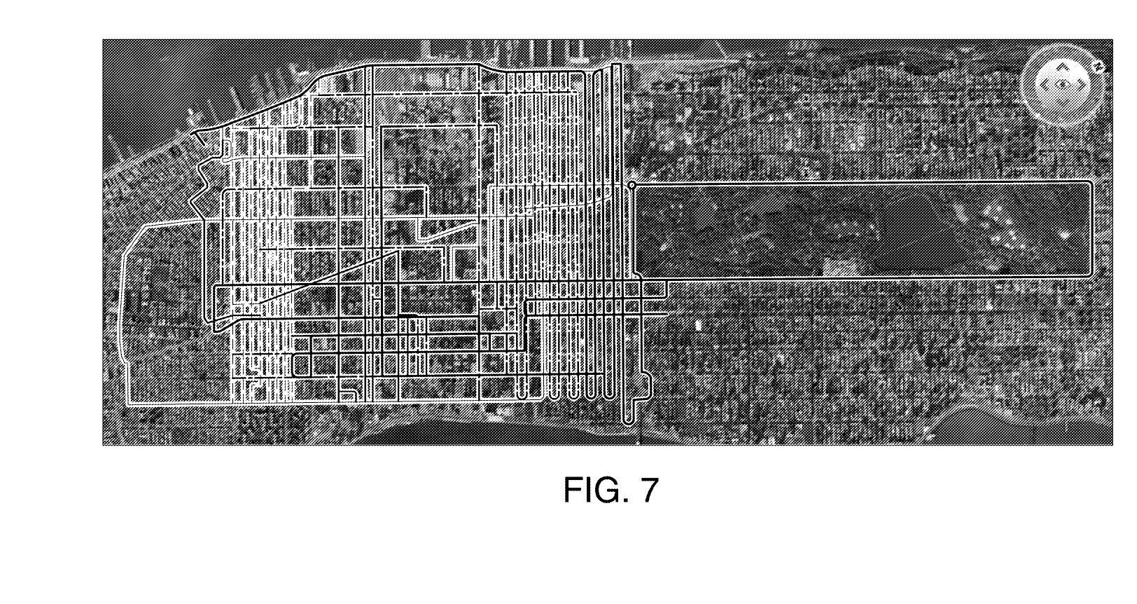

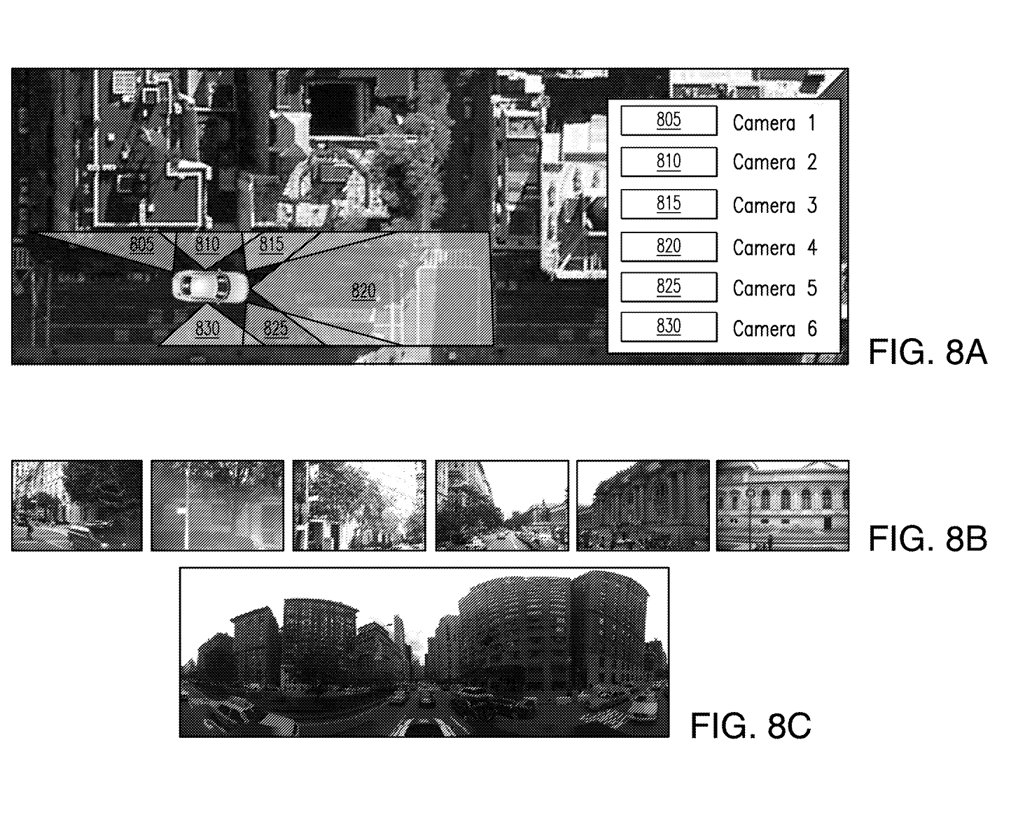

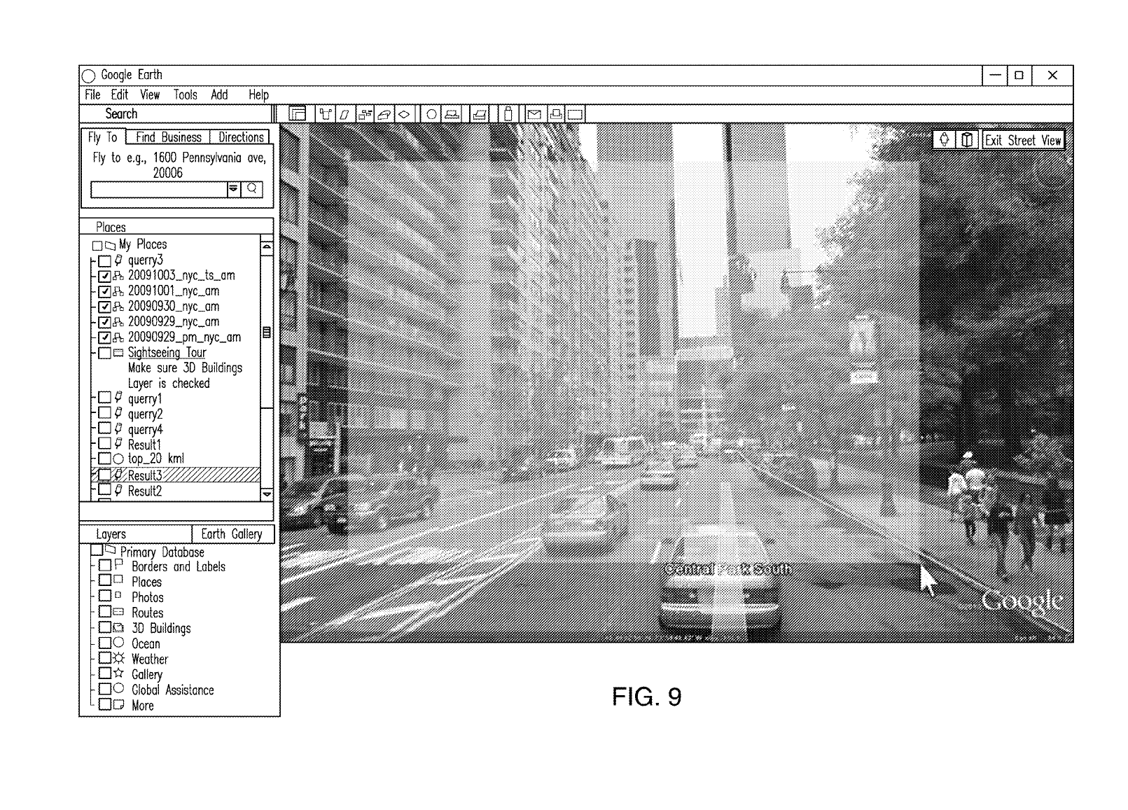

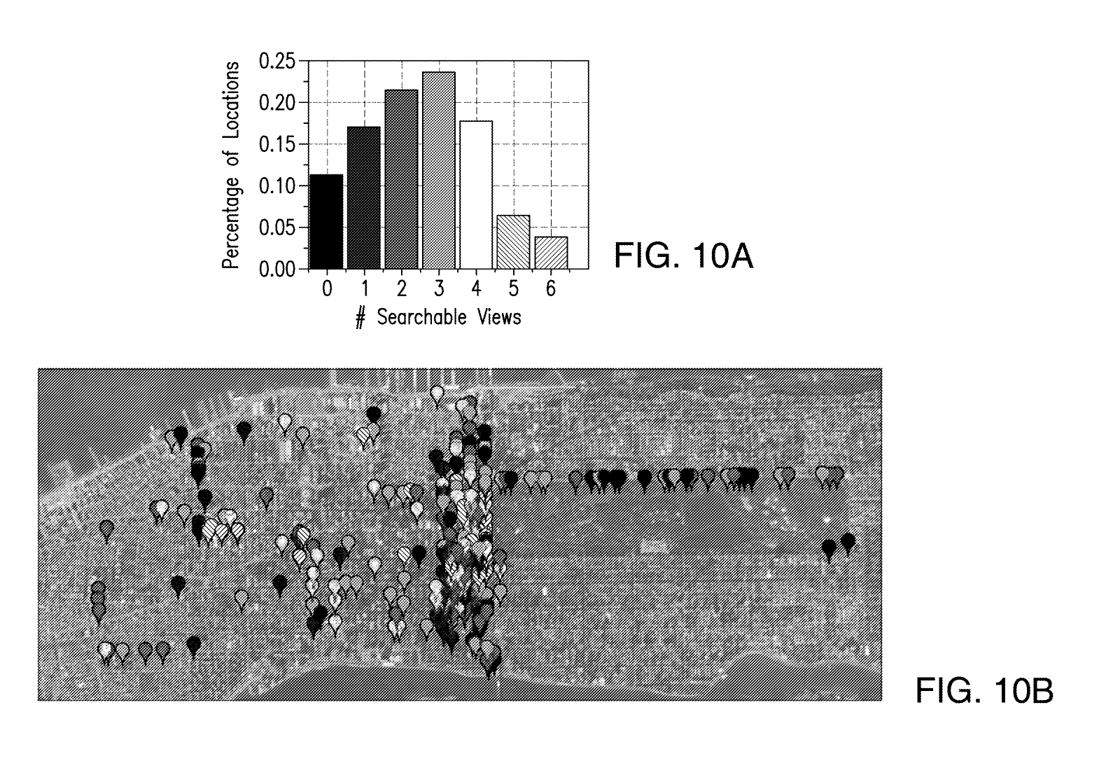

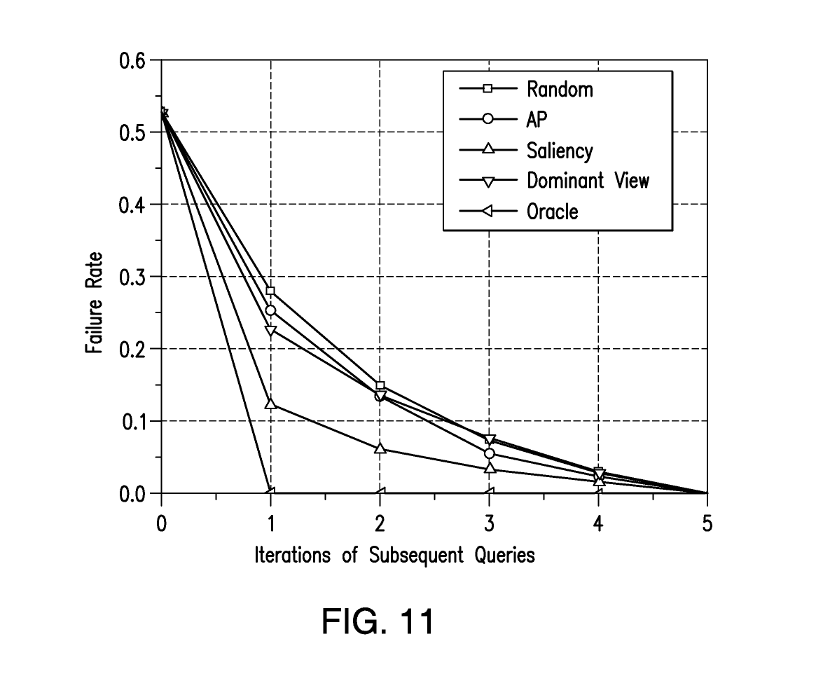

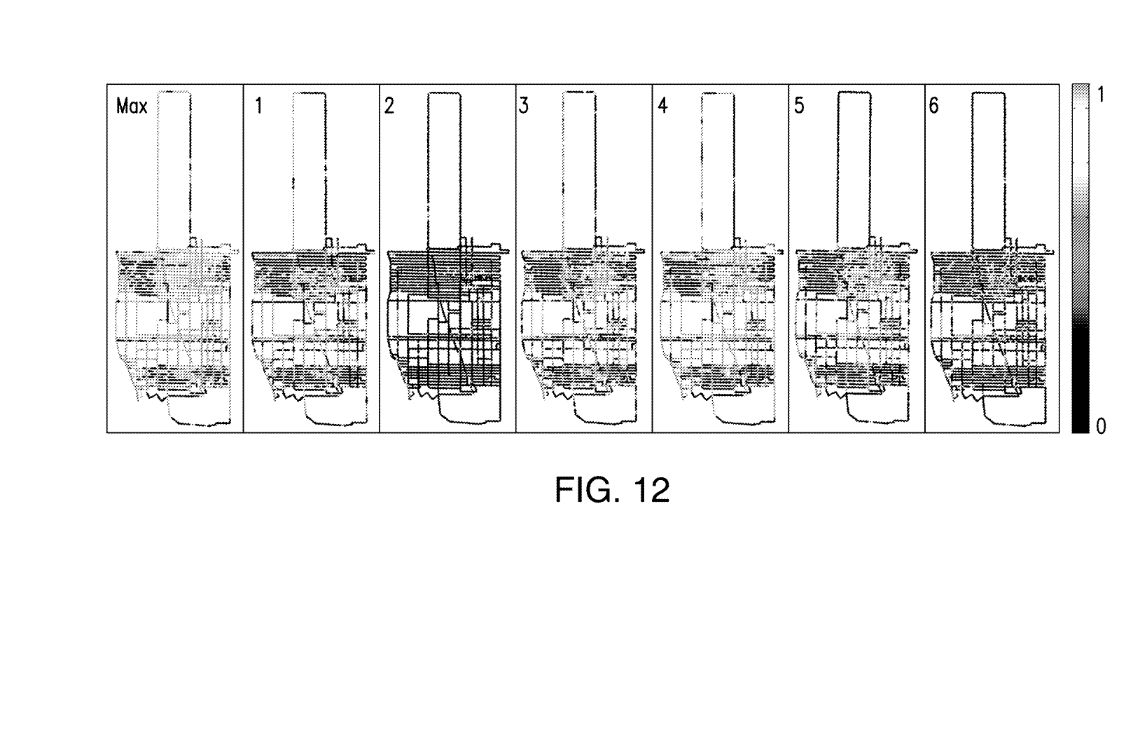

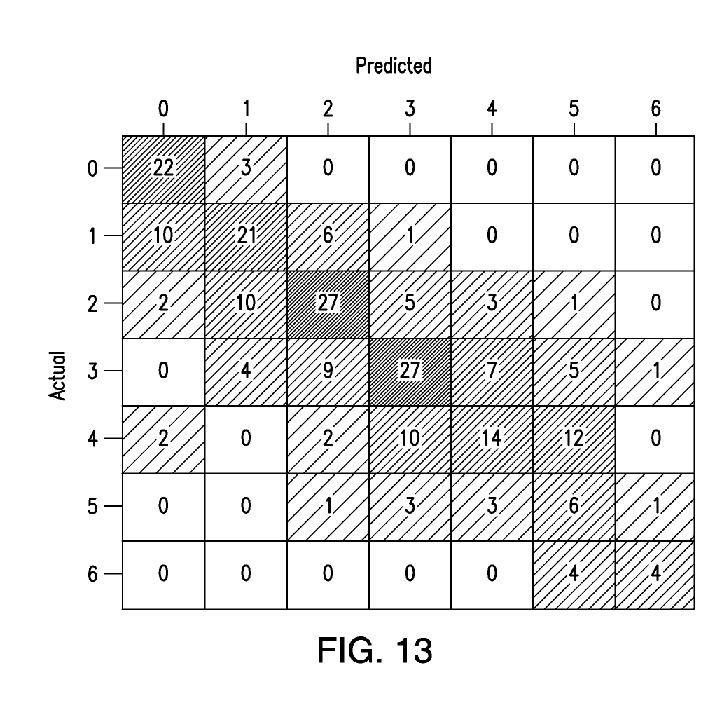

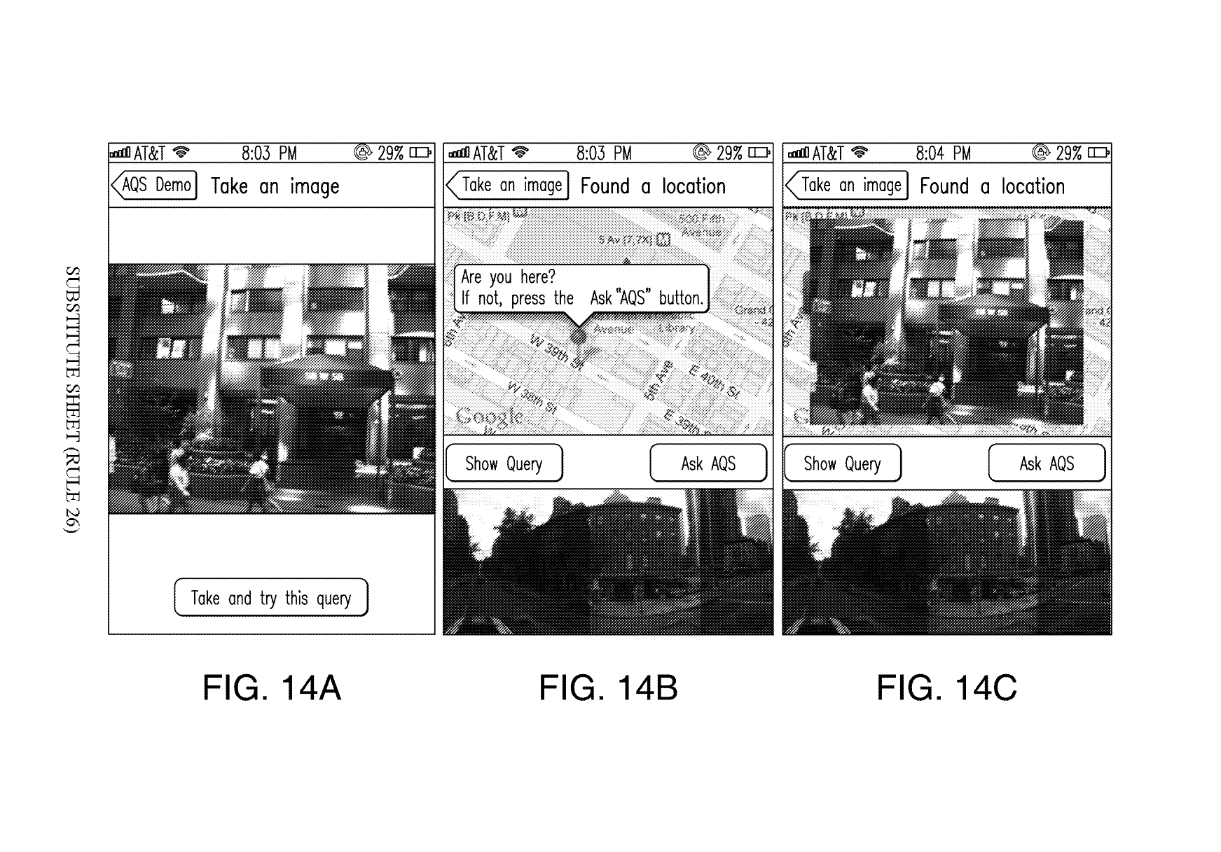

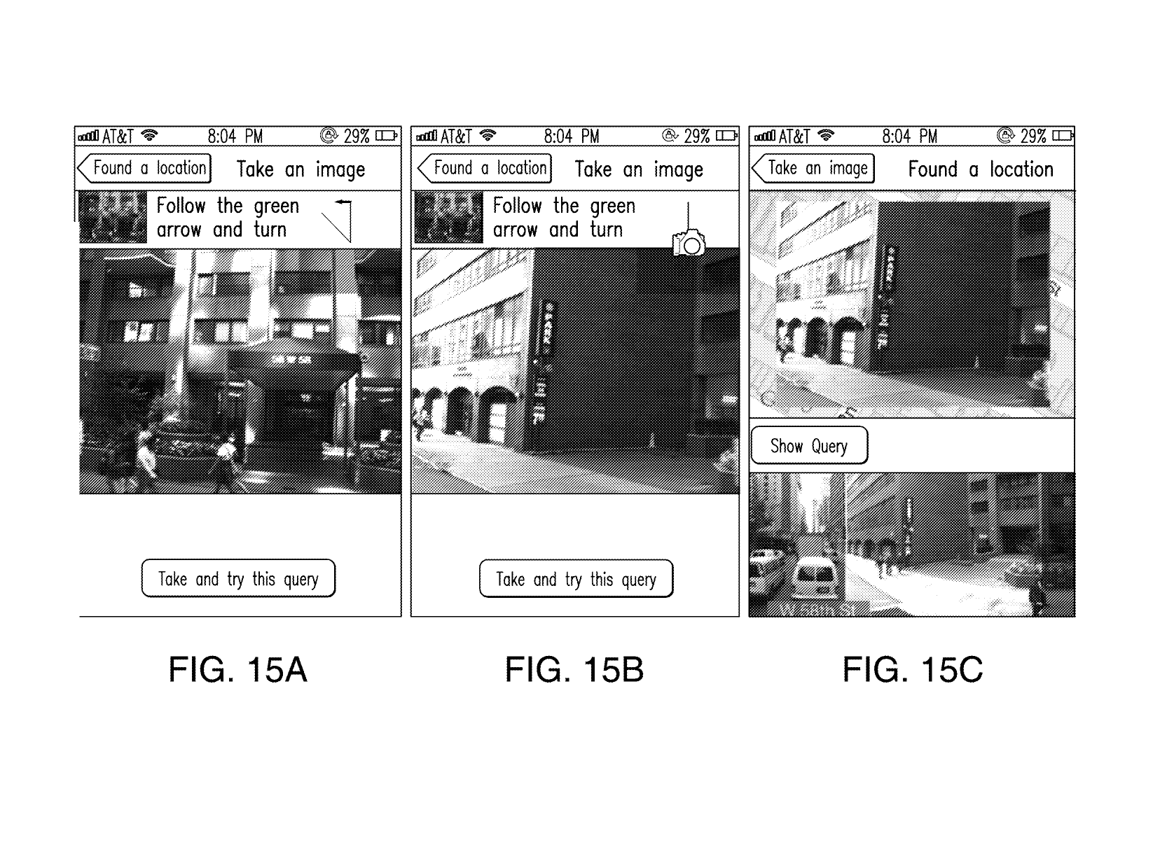

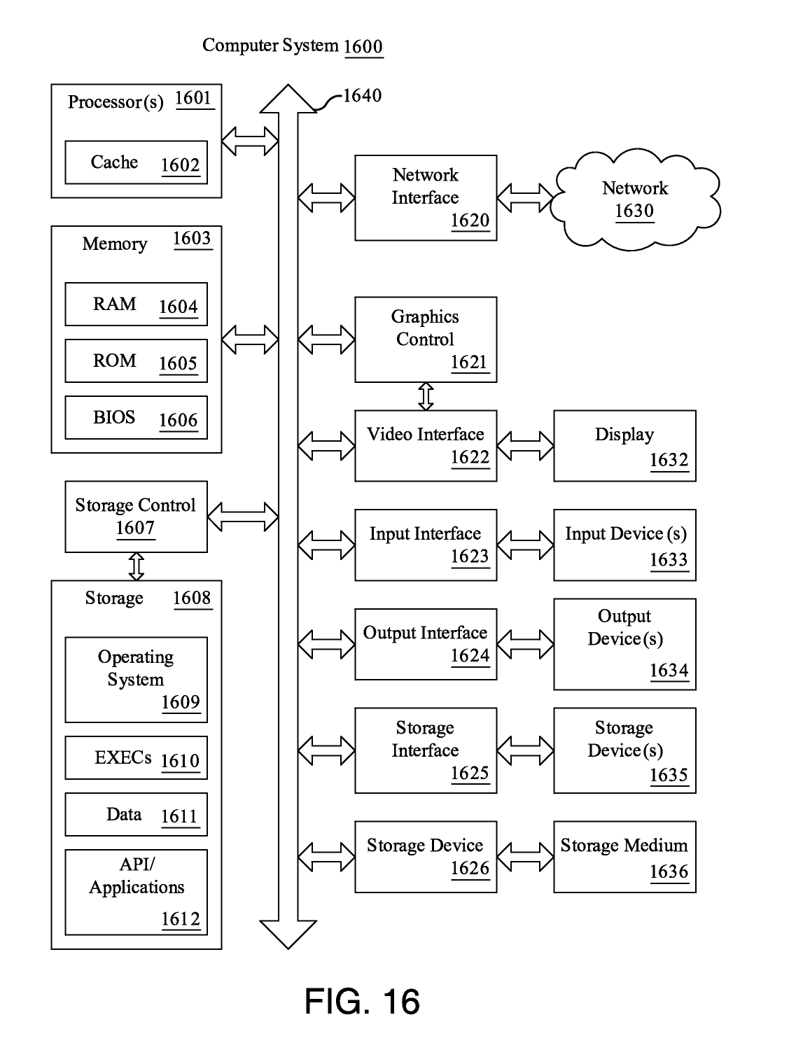

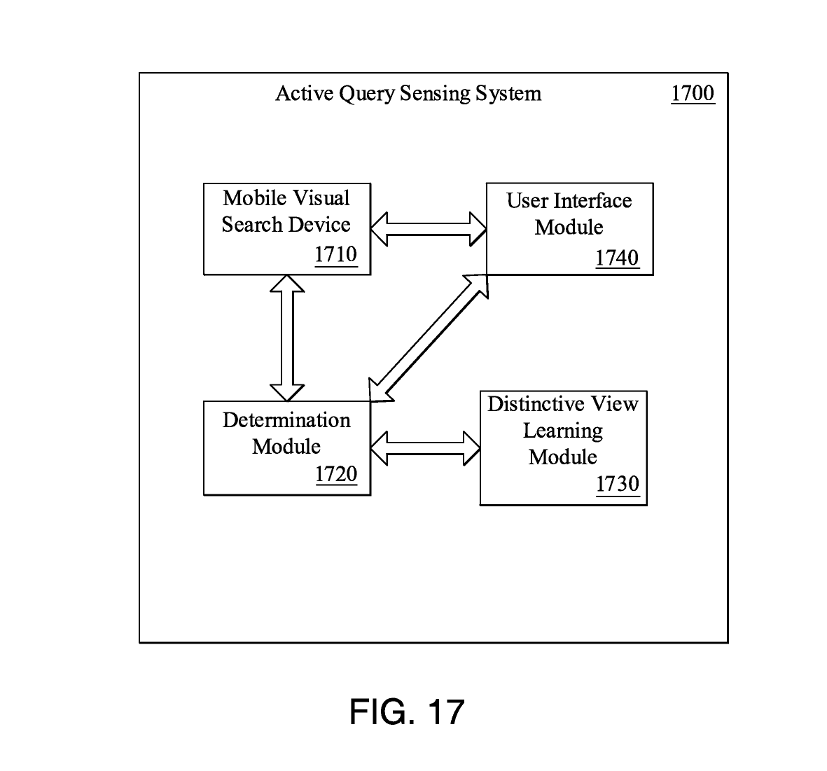

An analysis of a prior art system without the benefit of the disclosed subject matter was performed. Referring now to FIG. 7, a data set provided by NAVTEQ for New York City locations consists of close to 300,000 images of about 50,000 locations collected by the NAVTEQ street view imaging system during September and October of 2009 over 5 routes, as shown in FIG. 7. Data for each geographical location includes six surrounding views separated by 45 degrees, captured by high-definition cameras (e.g., commercially available from Prosilica). Note the right rear view and the rear view are not included in this data set. The locations are imaged at a four meter interval. The view orientations are shown in FIG. 8A and a typical example of six photos of a location is shown in FIG. 8B. The view orientations in FIG. 8A are back left 805, left 810, front left 815, front 820, front right 825, and right 830. In addition, for each location there is also a panorama image captured by the panoramic camera (e.g., the commercially available Ladybug 3 camera), examples of which are shown in FIG. 8C. The images are geo-tagged based on information received from a GPS system, an Inertial Measurement Unit (“IMU”), and a Distance Measurement Instrument (“DMI”) on the mobile imaging vehicle.

The mobile location search scenarios were simulated by creating a test set using the Google Street View interface. Queries were manually cropped from Google Street View for 226 randomly chosen locations covered by the above-mentioned routes in NYC. Although such test images are less ideal compared to real photos captured by mobile phones, they were used for initial testing since the Google images are quite different from the reference images in the NAVTEQ data set, and challenging conditions (e.g., occlusion and time change) can be presented. FIG. 9 shows an example of a screen dump of a cropped image from Google Street View interface.

For each location, six query images were cropped from viewing angles similar to the view orientations used in the database (as shown in FIG. 8A). This resulted in 1,356 images with angles and ground truth locations tags. For each query image, a returned reference image was considered relevant if it had visual overlap with the query image, as shown in FIG. 8. Due to the fixed geometry and interval used in image acquisition, the ground truths of each query result set can be computed without the laborious manual annotation. Depending on the view angle of a reference image, the number of relevant images in the database varies. The front view has more relevant images as its field of view overlaps with more images. Note this is different from the ground truth definition for locations that based on a certain distance threshold.

For each simulated query image from each of the random locations, the most likely location (among the 50,000 locations in the database) was returned having the highest aggregated matching scores between the query image and the multiple views associated with the location. Details of the matching process are described in more detail above. A returned location is considered correct if it is within a distance threshold from the query location. Setting the appropriate threshold involves consideration of several factors, such as the application requirements and the visual overlap of reference images. It was set to 200 meters in this initial study since two locations can still share overlapped views at this distance in the data set.

FIG. 10A shows the proportions of locations that can be correctly recognized without the aid of AQS. The locations are broken to groups that can be recognized by a different number of searchable views (0 to 6). 11.1% of the locations could not be recognized using any of the views cropped from the same location on Google Street View. 3.5% of the locations could be correctly recognized by all of their six constituent views. The rest of locations (85.4%) were recognizable only with a subset of the views, with most locations being searchable by 3 of the 6 views. This confirms that each location has a unique subset of preferred views for recognition. In addition, only 42.1% of the test query images from Google Street View were successful. This indicates that if a mobile user randomly selects views for location search, more than half of the times the user will not get correct results (even if the distance threshold is set to be quite forgiving, e.g., 200 m).

Another finding of the case study is Location Dependence. FIG. 10B shows the distribution of the locations with different numbers of searchable views. This shows that different locations have different degrees of “difficulty,” i.e., some have more searchable angles than others. Additionally, at least in this case, locations of the same search difficulty did not significantly cluster together. It was also found that there is no single dominant view that can successfully recognize all locations, though some views (e.g., the front view) tended to be more effective than others, at least in this case. Finally, only 3.5% of location could be correctly searched when using a random query viewing angle.

### Example 2

### Analysis of an Example AQS System

The performance of the components and overall system of an embodiment of the disclosed subject matter was evaluated using the NAVTEQ NYC data set (about 300,000 images, 50,000 locations). The test queries are the 1,356 images over 226 locations randomly cropped from the Google Street View interface as described above. Out of the 226 locations, 11.1% were found to be unsearchable by any of the views and thus were discarded. The remaining 201 locations are searchable by at least one view angle. The proportions of locations searchable by various numbers of views are shown in FIG. 10A.

First the “dominance” of each view of the query was analyzed. Table 2 shows the percentages of successful searches over the 201 test locations by each of the six views. Each view has a reasonable chance of success (between 35% and 65%) while View 2 (left) has the lowest rate. This can be due to the relatively low quality of the camera used for View 2 in the database. View 4 (front), the one pointing to the front of the imaging vehicle, has the highest success rate as it appears to cover highly visual objects (e.g., buildings on both sides), as well as distinctive features such as sky lies.

TABLE 2
Percentages of Successful Location Search Using Query Images From
Different Views

| | | | | View 5 | |
|---|---|---|---|---|---|
| View 1 | View 2 | View 3 | View 4 | (Front | View 6 |
| (Back Left) | (Left) | (Front Left) | (Front) | Right) | (Right) |
| 0.45 | 0.26 | 0.58 | 0.65 | 0.53 | 0.35 |

Distinctive View Prediction:

Next, the performance of predicting search robustness was evaluated using offline distinctiveness analysis. Table 3 shows the percentages of successful searches over 201 test locations by using different methods to predict an improved view for each test location. The two types of proposed methods: training performance based (AP and Saliency), and content based (IDF SVM classifier), against the random view selection and the one that always chooses a dominant view (front). Among all the competing approaches, the distinctivness measure (as defined in Equation 3) incorporating the score statistics ratio between the positive training group and the negative group turned out to achieve the highest performance (84%) with a large margin over other approaches (the next best one is 68% achieved by AP).

TABLE 3
Location search accuracy using different methods in predicting an
improved query view for each location

| | | Dominant | Content | | |
|---|---|---|---|---|---|
| Method | Random | Angle | Based | AP | Saliency |
| % correct | 0.4735 | 0.6517 | 0.5521 | 0.6816 | 0.8458 |
| prediction | | | | | |

For each location, the external mobile query was picked up with the most distinctive angle predicted offline. Then, it was tested whether or not the true location can be found using this query. Table 3 shows the robustness validation of different view discrimination measurements. For content based approach (SVM based on statistics of distinctive features), K=10 was set in Equation 1. For each testing location, SVM classifier was used to get the probability based classification results, and the viewing angle with largest probability to be discriminative is predicted to be the most distinctive viewing angle. The result is based on a five-fold cross validation on the test set. As shown in Table 3, the Saliency measurement obtains the highest score.

Query View Prediction:

For the module of view estimation of test queries, it was found that the GIST based SVM classifier was able to achieve 86.5% classification accuracy over the 1,356 test image queries using only Views 1-4. When Views 5 and 6 are added, they cause confusion with views of highly similar content (View 1 with View 5, and View 2 with View 6). This can be due to the symmetry between the views (180 degree opposite direction) giving rise to similar visual content. To resolve this, a maximal voting scheme based on image matching scores (as described in Equation 4) was applied. This kept the view estimation accuracy as high as 82.1% among all six view angles.

Active Query View Sensing:

The effectiveness of the example AQS system in helping users choose an improved view for subsequent queries after the first query fails was evaluated. The simulated system was initialized with a randomly chosen viewing angle in the first visual search. As shown in FIG. 11, 47% of the random query images succeeded, resulting in a 53% failure rate after the first query. The performance of reducing the failure rates in subsequent queries by using different active query strategies was then evaluated, including the proposed AQS method based on view distinctiveness measure, other methods based on AP, dominant view, random selection, and the oracle scheme which knows the correct answers and always chooses a successful view after the first query. The Saliency-based example AQS system yielded a 12% error rate after only one additional query compared to the next best one 23% by the dominant view. As the number of query iterations increases, the example AQS system consistently maintains a significant advantage over all other methods.

Location Difficulty Level Prediction:

How well the proposed distinctiveness measure can be used to predict the difficulty level of each location in terms of location recognition was further evaluated. Accurate prediction of a confidence distribution map such as the one shown in FIG. 10B can facilitate development of very interesting applications. For example, users can use such information to determine how much to trust the visual search based location information when he/she has additional information (like GPS) to roughly know the geographical region he/she is located in.

FIG. 12 shows the distribution of distinctiveness for each viewing angle as well as the maximum among all views of each location computed from the NYC data set. To avoid outliers caused by poor image quality or missing data, a simple Gaussian smoothing filter can also be used. By thresholding the distinctiveness values in each view, the number of views that can be used to successfully search each location was evaluated. The estimated number of successful views was compared against the ground truths associated with the 1,356 test query images from Google Street View. The confusion matrix, shown in FIG. 13, confirms the effectiveness of the proposed distinctiveness based estimation.

FIGS. 14 and 15 show a user interface for one example embodiment for enabling a user to conveniently indicate that the first returned location is incorrect, and then follow the systems suggestion to turn the camera viewing angle. In particular, the system workflow, user interface design, and client-server communication process of the embodiment will be described. Various user-interface configurations can be used and will be apparent to a person of ordinary skill in the art.

The procedure of an example AQS system includes:
As shown in FIG. 14A, a user captures a query image of the surroundings using a mobile camera. The image (or alternatively the extracted compact descriptor) is sent to the server through the wireless link.
The AQS search system receives the visual query, searches relevant locations based on the techniques described above and returns the top matched location.
As shown in FIGS. 14B and 14C, after checking and comparing the panorama and points of interest associated with the first returned location, if the user determines the predicted location is wrong, the user can initiate the AQS function to ask for a suggestion of an improved query view that can be used for the next query.
In some embodiments, when the user is not sure about the correctness of the initial search result, the system can provide extra information such as street names, landmarks in the vicinity, etc. to aid the user's decision.
Upon the user request, the system calls the AQS module to come up with an improved view for the next query. This is done by sending specific instructions to the user (e.g., turn right by 45 degrees). FIG. 15A shows an example interface, indicating how the user is guided to follow the suggested view change. As shown in FIG. 15B, the user can follow the suggestion to turn the camera and take the next query image, which, as shown in FIG. 15C, is sent for another round of location search.
FIGS. 15A and 15B show an example embodiment of the disclosed subject matter that also includes a visual compass to guide the camera turning process. As shown in the upper right corner of FIG. 15A, the visual compass includes a needle showing the current view angle and another needle showing the suggested target angle. As shown in the upper right corner of FIG. 15B, when the user turns the camera to the suggested angle, an icon “camera” appears to inform the user that the suggested angle has been reached.

The hardware architecture of an example embodiment of the disclosed subject matter will now be discussed. The example embodiment includes a search server and client applications using iPhone4S. The mobile applications communicate with the server through Wi-Fi or cellular data services. A client-server architecture for the communication process is used. The query and search results are uploaded and downloaded through PHP and HTTP. The client program processes and compresses the image with objective-C's CGImage Class. To support multiple simultaneous users, this example embodiment system uses the built-in iOS device ID. Various devices and configurations can be used and will be apparent to a person of ordinary skill in the art.

Using embodiments of the disclosed subject matter, over 0.3 million images can be searched within 2 seconds over Wi-Fi, including all end to end processes starting with query image uploading, communication, feature extraction, searching, and download of panorama and map information of search results. To further speed up system response, several state-of-the-art techniques such as those extracting and sending compact descriptors instead of the query image can also be used.

The methods for automatically determining an improved current view for a visual query in a mobile location search, described above, can be implemented as computer software using computer-readable instructions and physically stored in computer-readable media. The computer software can be written in any suitable computer languages, as would be apparent to one of ordinary skill in the art. The software instructions can be executed on various types of computers.

For example, FIG. 16 illustrates a computer system 1600 suitable for implementing embodiments of the present disclosure. Computer system 1600 can have many physical forms including an integrated circuit, a printed circuit board, a small handheld device (such as a mobile telephone or PDA), a personal computer or a super computer system 1600 includes a display 1632, one or more input devices 1633 (e.g., keypad, keyboard, mouse, stylus, etc.), one or more output devices 1634 (e.g., speaker), one or more storage devices 1635, various types of storage medium 1636. The system bus 1640 links a wide variety of subsystems. As understood by those skilled in the art, a “bus” refers to a plurality of digital signal lines serving a common function. The system bus 1640 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1601 (also referred to as central processing units, or CPUs) optionally contain a cache memory unit 1602 for temporary local storage of instructions, data, or computer addresses. Processor(s) 1601 are coupled to storage devices including memory 1603. Memory 1603 includes random access memory (RAM) 1604 and read-only memory (ROM) 1605. As is well known in the art, ROM 1605 acts to transfer data and instructions uni-directionally to the processor(s) 1601, and RAM 1604 is used typically to transfer data and instructions in a bi-directional manner. Both of these types of memories can include any suitable of the computer-readable media described below.

A fixed storage 1608 is also coupled bi-directionally to the processor(s) 1601, optionally via a storage control unit 1607. It provides additional data storage capacity and can also include any of the computer-readable media described below. Storage 1608 can be used to store operating system 1609, EXECs 1610, application programs 1612, data 1611 and the like and is typically a secondary storage medium (such as a hard disk) that is slower than primary storage. It should be appreciated that the information retained within storage 1608, can, in appropriate cases, be incorporated in standard fashion as virtual memory in memory 1603.

Processor(s) 1601 is also coupled to a variety of interfaces such as graphics control 1621, video interface 1622, input interface 1623, output interface 1624, storage interface 1625, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1601 can be coupled to another computer or telecommunications network 1630 using network interface 1620. With such a network interface 1620, it is contemplated that the CPU 1601 might receive information from the network 1630, or might output information to the network in the course of performing the above-described method. Furthermore, method embodiments of the present disclosure can execute solely upon CPU 1601 or can execute over a network 1630 such as the Internet in conjunction with a remote CPU 1601 that shares a portion of the processing.

According to various embodiments, when in a network environment, i.e., when computer system 1600 is connected to network 1630, computer system 1600 can communicate with other devices that are also connected to network 1630. Communications can be sent to and from computer system 1600 via network interface 1620. For example, incoming communications, such as a request or a response from another device, in the form of one or more packets, can be received from network 1630 at network interface 1620 and stored in selected sections in memory 1603 for processing. Outgoing communications, such as a request or a response to another device, again in the form of one or more packets, can also be stored in selected sections in memory 1603 and sent out to network 1630 at network interface 1620. Processor(s) 1601 can access these communication packets stored in memory 1603 for processing. The components shown in FIG. 16 for computer system 1600 are non-exhaustive examples and are not intended to suggest any limitation as to the scope of use or functionality of the computer software implementing embodiments of the present disclosure. Neither should the configuration of components be interpreted as having any dependency or requirement relating to any one or combination of components illustrated in the example embodiment of a computer system.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 1600 can provide functionality as a result of processor(s) 1601 executing software embodied in one or more tangible, computer-readable media, such as memory 1603. The software implementing various embodiments of the present disclosure can be stored in memory 1603 and executed by processor(s) 1601. A computer-readable medium can include one or more memory devices, according to particular needs. Memory 1603 can read the software from one or more other computer-readable media, such as mass storage device(s) 1635 or from one or more other sources via communication interface. The software can cause processor(s) 1601 to execute particular processes or particular parts of particular processes described herein, including defining data structures stored in memory 1603 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

FIG. 17 shows an Active Query Sensing system 1700 according to some embodiments of the disclosed subject matter. The system 1700 includes a mobile visual search device 1710, a determination module 1720, a distinctive view learning module 1730, and a user interface module 1740. The mobile visual search device 1710 is coupled to the determination module 1720. The distinctive view learning module 1730 is coupled to the determination module 1720. The user interface module 1740 can be coupled to the mobile visual search device 1710 and/or the determination module 1720. The system 1700 can be configured to implement the methods described above, e.g., by way of a computer system 1600 configured as shown in FIG. 16.

For example, the mobile visual search device 1710 can be configured to obtain a result data set in response to an initial visual query. The determination module 1720 can receive the result data set from the mobile visual search device 1710, and can be configured to retrieve distinctiveness measurements for results in the result data set. The determination module 1720 can determine the improved view based on the retrieved distinctiveness measurements.

The system 1700 can also include a distinctive view learning module 1730 configured to pre-compute the distinctiveness measurements of views for the results in the result data set using one or both of content based view distinctiveness prediction and training performance based view distinctiveness prediction as described above.

The system 1700 can also include a user interface module 1740 configured to provide images of views of results from the result data set as shown in FIG. 14. The user interface module 1740 can also be configured to provide a suggested view change for the current visual query to a user based on the difference between the viewing angle of the prior query and the determined improved view as shown in FIG. 15.

While this disclosure has described several example embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

1. A method for automatically determining an improved view for a visual query in a mobile search system, comprising:
obtaining at least one result data set based on a prior visual query, wherein the at least one result data set includes at least a top result and one or more other results;
retrieving at least one distinctiveness measurement for one or more views of one or more objects in the at least one result data set; and
determining the improved view based on the retrieved at least one distinctiveness measurement.

2. The method of claim 1, wherein the determining the improved view comprises an information gain maximization process.

3. The method of claim 1, wherein the determining the improved view comprises a majority voting process.

4. The method of claim 1 further comprising estimating a viewing angle of the prior query and determining outlier results, if any, from the at least one result data set based on the estimated viewing angle of the prior query, and removing from the at least one result data set the determined outlier results.

5. The method of claim 4 wherein the estimating the viewing angle of the prior query comprises using machine learning classification or local feature matching based image alignment.

6. The method of claim 5, wherein the machine learning classification comprises a Support Vector Machine classification

7. The method of claim 6 wherein the estimating a viewing angle of the prior query further comprises refining the estimate based on machine learning classification using image matching results from comparing the prior query and one or more results in the at least one result data set.

8. The method of claim 7, further comprising providing a suggested view change for the current visual query to a mobile search system user based on the difference between the viewing angle of the prior query and the determined improved view.

9. The method of claim 8 further comprising providing images of one or more views of one or more results from the at least one result data set.

10. The method of claim 9, further comprising prompting the user to indicate whether the improved view is to be determined.

11. The method of claim 10, wherein the retrieving and determining are initiated only after the user has indicated that the improved view is to be determined.

12. The method of claim 10, wherein the retrieving and determining are initiated independent of whether the user has indicated that the improved view is to be determined, and wherein the suggested view change is provided only after the user has indicated that the improved view is to be determined.

13. The method of claim 1, wherein the distinctiveness measurements of at least one view for the one or more results in the at least one result data set are pre-computed using one or both of content based view distinctiveness prediction and training performance based view distinctiveness prediction.

14. The method of claim 1, wherein the visual query comprises a location query.

15. The method of claim 14 further comprising removing from the at least one result data set the top result and all other results geographically close to the top result, wherein the top result of the at least one result data set is deemed incorrect.

16. A non-transitory computer-readable medium having a set of instructions programmed to perform the methods of any one of claims 1-15.

17. An active query sensing system for automatically determining an improved view for a visual query in a mobile search, comprising:
a mobile visual search device, configured to obtain at least one result data set based on a prior visual query, wherein the at least one result data set includes at least a top result and one or more other results; and
a determination module, coupled to the mobile visual search device for reception of the at least one result data set, configured to retrieve at least one distinctiveness measurement for one or more results in the at least one result data set, and determine the improved view based on the retrieved at least one distinctiveness measurement.

18. The system of claim 17 further comprising a user interface module coupled to the determination module, configured to provide images of one or more views of one or more results from the at least one result data set.

19. The system of claim 17, further comprising a distinctive view learning module, coupled to the determining module, and configured to pre-compute the distinctiveness measurements of at least one view for the one or more results in the at least one result data set using one or both of content based view distinctiveness prediction and training performance based view distinctiveness prediction.

20. The system of claim 17, wherein the visual query comprises a location query.
